(19) United States
(12) Patent Application Publication
(10) Pub. No.: US 2025/0252027 A1
(43) Pub. Date: Aug. 7, 2025

(54) COMPRESSING HISTOGRAMS IN A MEMORY DEVICE

(71) Applicant: Micron Technology, Inc., Boise, ID (US)

(72) Inventors: Lei Zhang, SG (SG); Tingjun Xie, Milpitas, CA (US)

(21) Appl. No.: 19/043,006

(22) Filed: Jan. 31, 2025

Related U.S. Application Data
(60) Provisional application No. 63/548,617, filed on Feb. 1, 2024.

(51) Int. Cl. G06F 11/30; G06F 11/32

(52) U.S. Cl. CPC G06F 11/3037; G06F 11/3075; G06F 11/323

(57) ABSTRACT

Systems and methods are disclosed including a memory device and a processing device operatively coupled to the memory device. The processing device can perform operations comprising performing a media scan on a portion of the memory device to obtain a metrics dataset comprising a plurality of data state metric values; generating, for the metrics dataset, a plurality of data state metric bins comprising a first set of bins having a first bin width and a second set of bins having a second bin width; associating a first data state metric value of the plurality of data state metric values with a first bin of first set of bins, and a second data state metric value of the plurality of data state metric values with a second bin of the second set of bins; and generating a histogram reflecting the data associated with the plurality of data state metric bins.

This application claims the benefit of U.S. Provisional Application No. 63/548,617, filed Feb. 1, 2024, the entire content of which is hereby incorporated by reference.

### TECHNICAL FIELD

Implementations of the disclosure relate generally to memory sub-systems, and more specifically, relate to performing operations related to compressing histograms in a memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 illustrates an example computing system that includes a memory sub-system, in accordance with some implementations of the present disclosure.

FIG. 2 is a schematically illustrates example metadata maintained by metrics management component for recording instances of bit errors per codeword to respective bins, in accordance with some implementations of the present disclosure.

FIGS. 3A-3B are graphs illustrating properties of bins that were generated using an exponential technique, in accordance with implementations of the present disclosure.

FIGS. 4A-4B are graphs that illustrate properties of bins that were generated using a piecewise linearization technique, in accordance with implementations of the present disclosure.

FIGS. 5A-5B are graphs that illustrate another set of bins generated using a piecewise linearization technique, in accordance with implementations of the present disclosure.

FIG. 6 is a flow diagram for compressing a histogram reflecting the data stored in the metadata table, in accordance with some implementations of the present disclosure.

FIG. 7 is an example quality metric generated from a bit error count metadata table, according to implementations of the present disclosure.

FIG. 8 is a block diagram of an example computer system in which implementations of the present disclosure may operate.

### DETAILED DESCRIPTION

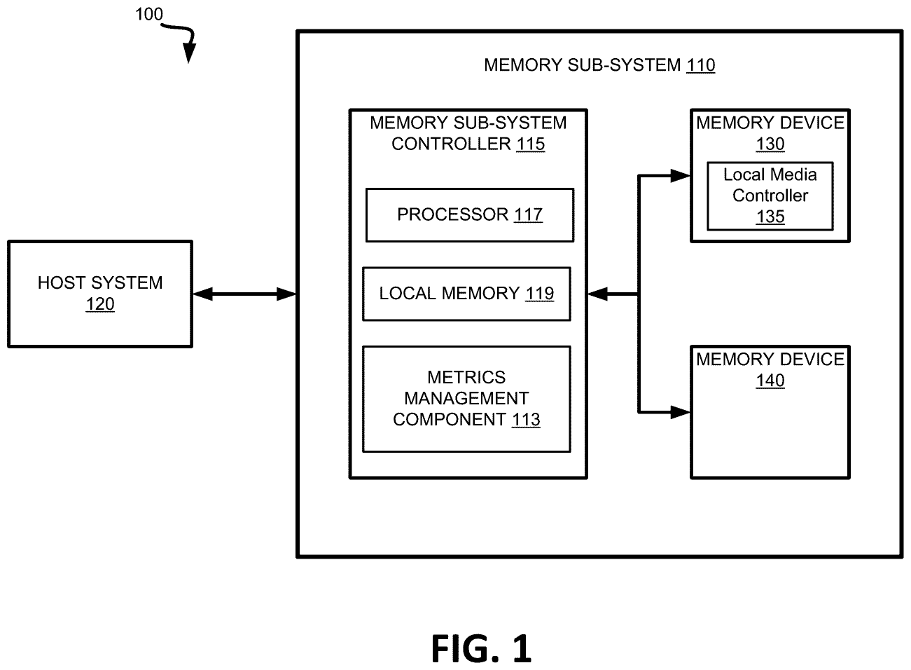

Aspects of the present disclosure are directed to performing operations related to compressing histograms in a memory device. A memory sub-system can be a storage device, a memory module, or a combination of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A host system can initiate a memory access operation (e.g., a programming or write operation, a read operation, an erase operation, etc.) on a memory sub-system. For example, the host system can transmit a request to a memory sub-system controller, to program data to and/or read data from a memory device of the memory sub-system. Such data is referred to herein as “host data.” The memory sub-system controller can execute one or more operations to access the host data in accordance with the request. Host data can be encoded using error-correcting code (ECC)) to correct data errors that can occur during transmission or storage. In particular, an ECC encoder can encode the host data using redundancy metadata (e.g., parity data such as one or more parity bits) to form a codeword (e.g., original data appended with one or more correction bits). The parity data allows the memory sub-system controller to detect the errors in the host data, and often to correct these errors without retransmission. For example, when stored data is to be retrieved from the memory sub-system, an ECC decoder can use the corresponding codewords to identify bit errors in the encoded data. If bit errors are identified, one or more error correcting operations can be used to correct the bit errors and to recover the stored data.

In addition to generating error-checked and error-corrected data, some systems can also generate metadata regarding an ECC decode operation. For example, ECC operations can generate data state metrics corresponding to each decoded codeword. “Data state metric” herein shall refer to a quantity that is measured or inferred from the state of data stored on a memory device. One example of a data state metric is bit error count (BEC), which corresponds to the number of bit errors identified and/or corrected in a respective codeword. Another example of a data state metric is raw bit error rate (RBER), which corresponds to a number of bit errors per unit of time that the data stored at the data block experiences (e.g., BEC/total bits read).

A memory sub-system can use the data state metrics to provide an indication of the health or quality of memory regions storing each codeword. For example, these memory sub-systems can store the data using metadata tables and use to the data to generate a histogram of BEC values of different memory regions, which may be utilized to predict memory device failures. These metadata tables can collect the BEC data for different memory regions (e.g., different die) of the memory device by assigning each determined BEC value to a respective bin (e.g., a data state metric bin, such as a BEC bin). Each bin can represent a range (constrained by values referred to as “bin boundaries”) of bit errors per codeword. For example, a first bin can reflect how many codewords had between 0 and 3 bit errors per codeword (the bin boundaries being 0 and 3), a second bin can reflect how many codewords had between 4 and 7 bit errors per codeword (the bin boundaries being 4 and 7), and so forth. Due to frequent updates, these metadata tables can be maintained on volatile memory to minimize latency, and periodically stored to non-volatile memory. However, since these metadata have static bin width, the metadata tables (and the corresponding histograms) typically consume a relatively large amount of volatile memory, which further leads to excessive wear of the non-volatile memory due to the periodic storing if these memory consuming tables to the non-volatile memory. For example, a metadata table can store bit errors per codeword for 16 memory regions (referred to as “logical units” or “LUNs”) by using 64-bins, where each bin has a width of 4. Maintaining such a metadata table can consume approximately 32 kbs of volatile memory. Furthermore, since codewords typically have a relative low amount of bit errors during a memory device's early lifespan, most of the data is reflected in the first couple of bins (e.g., first five bins), while the remaining bins are unused but consume memory, thus the density of data is significantly higher in the first couple of bins. In addition, since memory devices are expanding in size and ECC operations are improving (e.g., current systems are able to correct a greater number of errors per codeword), current metadata tables are limited in their coverage of errors per codeword. For example, the 64-bin metadata table discussed above cannot collect data reflecting more than 255 bit errors per codeword, whereas current ECC operations may be able to correct more than 255 bit errors per codeword. Statically expanding the bins to, for example, be 8-bit wide bins would double the amount of memory needed to maintain the metadata table.

Aspects of the present disclosure address the above and other deficiencies by enabling memory sub-systems to compress histograms in a memory device. In particular, as discussed above, low BEC data (e.g., data reflective of codewords having between 1 and 5 bit errors per codeword) can be significantly denser than high BEC data (e.g., data reflective of codewords having 50 or more bit errors per codeword) since the frequency of codewords experiencing a relatively low number of bit errors per codeword can be significantly higher than the frequency of codewords experiencing a relatively high number of bit errors per codeword. To compress a histogram generated from the BEC data while preventing loss of detailed data (e.g., data indicative of BECs per codeword), aspects of the present disclosure enable a memory subsystem to perform certain compression techniques prior to assigning the BEC data to respective bins. These compression techniques can apply different resolutions to the BEC data to maintain data integrity. For example, the memory subsystem can apply a fine resolution (generate bins having a relatively small bin width, e.g., a bin width of 1-4) for low BEC data, and a high resolution (generate bins having a larger bin width, e.g., a bin width of 8-32) for high BEC data.

In some implementations, the memory sub-system controller can compression techniques such as an exponential technique or a piecewise linearization technique to generate the bin boundaries for a metadata table. These bin boundaries can be used to structure corresponding bins of variable bin width. By setting bins to variable widths, the memory sub-system controller can compress the metadata table (e.g., maintain fewer bins) without sacrificing detailed data (e.g., data indicative of BECs per codeword). For example, bins reflecting a relatively small amount of bit errors per codeword can be set to have relatively small bin width (e.g., a bin width of 1-4) and bins reflecting a larger number of bit errors per codeword can be set to a larger bin width (e.g., a bin width of 8-32).

Advantages of the systems and methods implemented in accordance with some implementations of the present disclosure include, but are not limited to, a reduction in memory used to maintain the metadata table used to generate histograms. This reduction in memory used also reduces wear on non-volatile memory due to using fewer write operations to store the metadata table. Other advantages will be apparent to those skilled in the art of folding data within memory devices, which will be discussed hereinafter.

FIG. 1 illustrates an example computing system 100 that includes a memory sub-system 110 in accordance with some implementations of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some implementations, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a negative-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some implementations, each of the memory devices 130 can include one or more arrays of memory cells such as SLCs, MLCs, TLCs, QLCs, PLCs or any combination of such. In some implementations, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some implementations, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another implementation of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some implementations, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some implementations, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some implementations, memory sub-system 110 is a managed memory device, which is a raw memory device 130 having control logic (e.g., local controller 132) on the die and a controller (e.g., memory sub-system controller 115) for media management within the same memory device package. An example of a managed memory device is a managed NAND (MNAND) device.

The memory sub-system 110 includes a metrics management component 113 that can manage the data used to generate histograms stored in memory device 130, 140, as described in more detail herein below. In some implementations, the memory sub-system controller 115 includes at least a portion of the media management component 113. For example, the memory sub-system controller 115 can include a processor 117 (processing device) configured to execute instructions stored in local memory 119 for performing the operations described herein. In some implementations, the media management component 113 is part of the host system 120, an application, or an operating system.

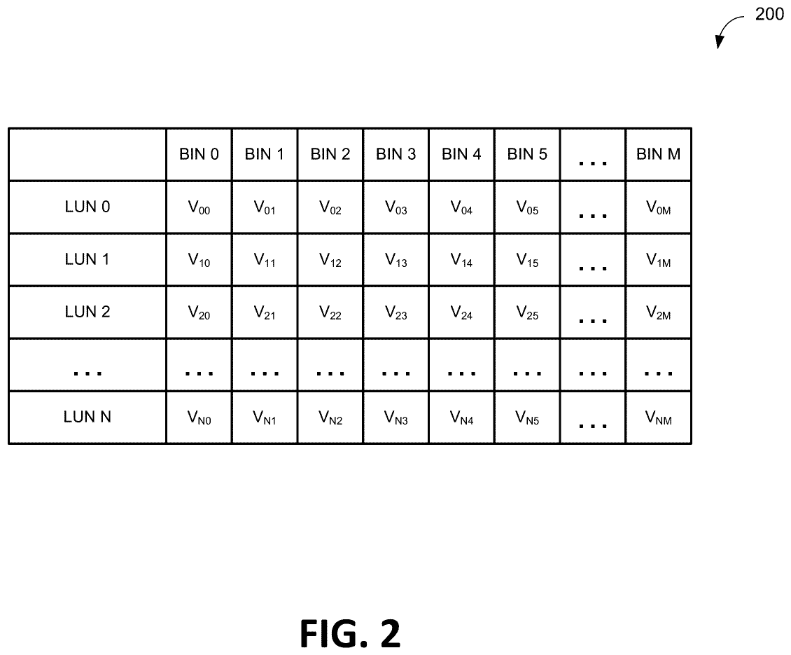

FIG. 2 schematically illustrates example metadata maintained by metrics management component 113 for recording instances of bit errors per codeword to respective bins, in accordance with implementations of the present disclosure. As schematically illustrated by FIG. 2, metrics management component 113 can maintain the table 200. By way of illustrative example, the data state metric maintained by table 200 is a BEC. However, it is noted that other date state metrics (e.g., RBER, bit error rate or bit error ration (BER), etc.) can be maintained by metrics management component 113.

Each record of table 200 specifies a logical unit, referred to as a “LUN,” (e.g., LUN 0, LUN 1, . . . , LUN N), that corresponds to a particular arrangement of memory cells or a specific memory region of a memory device (e.g., memory device 130, 140). In an example, a LUN can correspond to a die, a block, a page, a memory stripe, a management unit (MU) or any other measurable or manageable unit of the memory sub-system 110. For each LUN, table 200 is indexed by a set of bin columns. Each bin column is identified by a bin identifier (e.g., BIN 0, BIN 1, . . . , BIN M).

Each bin can represent limits defined by certain bin boundaries. Thus, each bin can used to record the number of instances a particular number or a range of bit errors per codeword occurred. To populate the bins, the media management component 113 can (e.g., during a media scan), identify the number of bit error per codeword for one or more particular LUNs and then record the number of codewords having a particular number of errors that is within the limits defined by the bin boundaries. Each bin can have a specific bin width. The bin width can reflect the number or range of different values recorded by each particular bin. In an example, a bin with a bin width of three stores the number instances of three different bit error counts (e.g., 0 bit errors per codeword, 1 bit error per codeword, and 2 bit errors per codeword).

In some implementations, each bin can represent upper and lower limits defined by representative value obtained by performing one or more mathematical operations on a respective number of bit error for a codeword. In such implementations, the media management component 113 can perform a media scan to identify the number of bit errors per codeword for a particular LUN, then perform a mathematical operation to convert the identified values to respective representative values. The representative value can then be stored to appropriate the bins. In an example where each bin stores a value or range reflecting representative values, a bin with a bin width of 2.5 stores values spanning a range of 2.5 (e.g., 0-2.5, 1-3.5, 4.5-7, etc.).

The value limits of the bin can be referred to as a bin boundary. For example, if a bin records instances of 0 bit errors per codeword, 1 bit error per codeword, and 2 bit errors per codeword, then the bin boundary of the bin is 0-2. In another example, if a bin records instances of values ranging from 6 through <8, then the bin boundary of the bin is 6 through <8.

Each value (e.g., V₀₀, V₀₁, . . . , V_{NM}) maintained by table 200 reflects the number of codewords identified that had the a number of bit errors (or a correlating representative value) corresponding to the appropriate bin. For example, V₀₀ indicates the number of codewords in LUN 0 that had bit errors between the bin boundaries of bin 0, Vu indicates the number of codewords in LUN 1 that had bit errors between the bin boundaries of bin 1, and so forth. A counter value of a bin can be incremented for each corresponding BEC value identified.

Metrics management component 113 can determine the bin boundaries for each bin for table 200. In some implementations, metrics management component 113 can use an exponential technique to generate the bin boundaries. In some implementations, metrics management component 113 can use a piecewise linearization technique. In some implementations, other techniques can be used to generate the bin boundaries.

An implementation of an exponential technique of the compression techniques can include metrics management component 113 generating the bin boundaries by applying one or more formulas where each bin number is used (alone or as part of an expression) as the exponent of a particular base value. In an illustrative example, metrics management component 113 can use the following formula, expressed as formula 1, to determine the bin upper boundaries for a set of bins:

$$Bin Upper Boundary = {B}_{1}^{Ibin * C 1 + C 2} , {L}_{1} \leq {I}_{bin} \leq {L}_{2} \qquad ( 1 )$$

$${B}_{2}^{Ibin *} , {L}_{3} \leq {I}_{bin} \leq {L}_{4}$$

where: I_{bin} is a particular Bin index number (e.g., 1, 2, 3, . . . , M), Bₓ represents one or more base values, L_{y} is a constraint value reflecting for which bins the corresponding equation is used, and C_{z} represents one or more value that can be used to modify the I_{bin} value.

An illustrative example of formula 1 can be seen below, expressed as formula 2, which can be used to determine the bin upper boundaries for bin 0-24,

$$Bin Upper Boundary = {2}^{Ibin} , 0 \leq {I}_{bin} \leq 5 \qquad ( 1 )$$

$$2 \frac{Ibin + 15}{4} , 6 \leq {I}_{bin} \leq 24$$

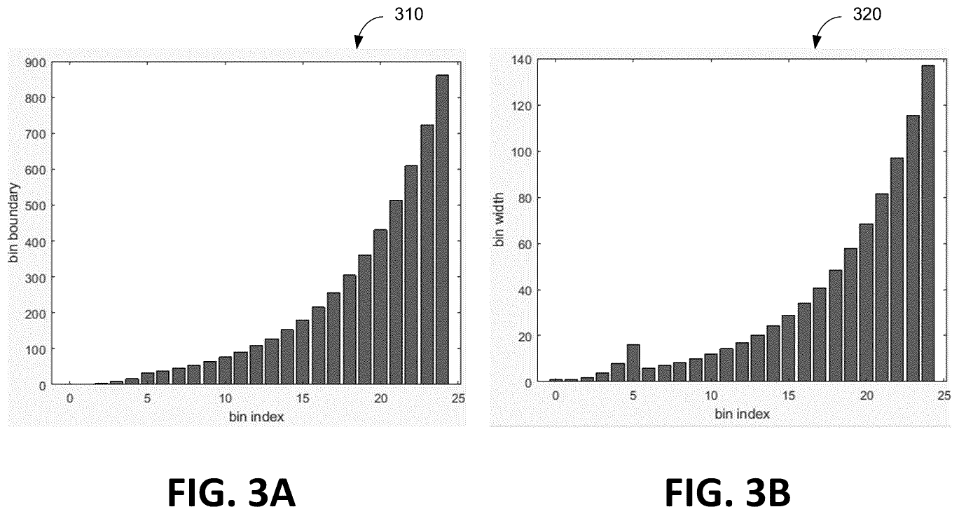

As shown in formula (2), for bins indexed as 0 through 5, to obtain the bin upper boundary, metrics management component 113 uses the sequential number of the respective bin as an exponential value to the base value of 2. The bin lower boundary for each bin can be obtained by adding a particular value (e.g., 1, 0.1, etc.) to the preceding upper bin boundary value. For example, using formula 2, the upper boundary of bin 5 is 32, the upper boundary of bin 4 is 16, thus the lower boundary of bin 5 is 17 (e.g., 16+1). The lower boundary of bin 0 can be set of 0. In some implementations, as shown with formula 2, different expressions can be used for different bin numbers to manage the bin width of bins, as will be shown below with regards to FIG. 3B.

FIGS. 3A-3B are graphs that illustrate properties of bins that were generated using formula 1, in accordance with implementations of the present disclosure. In particular, graph 310 of FIG. 3A illustrates the bin boundaries for a set of bins while FIG. 3B illustrates the bin width for the set of bins. In graph 310, the y-axis is indicative of the bin upper boundary value and the x-axis is indicative of the bin index (e.g., bin identifier). In graph 320, the y-axis is indicative of the bin width and the x-axis is indicative of the bin index.

As shown in graph 310, the first part of formula 2 (e.g., relating to bins 0-5) sets the bin boundaries of bin 0 to values between (e.g., values including, greater than, and/or less than) 0 and 1, the bin boundaries of bin 1 to values between 1 and 2, the bin boundaries of bin 2 to values between 2 and 4, the bin boundaries of bin 3 to values between 4 and 8, the bin boundaries of bin 4 to values between 8 and 16, and the bin boundaries of bin 5 to values between 16 and 32. The second part of formula 2 (e.g., relating to bins 6-24) sets the bin boundaries of bin 6 to values between 32 and 38, the bin boundaries of bin 7 to values between 38 and 45, the bin boundaries of bin 8 to values between 45 and 53, and so forth.

As shown in graph 320, the resulting bin boundaries set bin 0 to a width of 1, bin 1 to a width of 1, bin 2 to a width of 2, bin 3 to a width of 4, bin 4 to a width of 8, bin 5 to a width of 16, bin 6 to a width of 6, bin 7 to a width of 7, bin 8 to a width of 8, and so forth. As the bin index increases based on the second part of formula 1, the resolution of the bins goes from fine to course.

In some implementations, metrics management component 113 can generate a modified value by applying a modification operation to a data state metric value (e.g., a BEC value). The modified value can then be sorted into the appropriate bin. In some implementations, the modification operation can include a scaling the data state metric, converting the data state metric, transforming the data state metric, or any other value modifying operation. In an illustrative example, the modification operation can include a scaling a BEC value by applying a logarithmic scaling function (e.g., log₂( )). For example, for each obtained BEC value, the metrics management component 113 can generate a modified value by inputting the BEC value into the logarithmic scaling function of log₂( ) The modified value can then be sorted into, for example, the appropriate bin of table 200.

An implementation of a piecewise linearization technique can include metrics management component 113 generating the bin boundaries by applying one or more formulas where each bin number is multiplied by a value and offset by another value. In an illustrative example, metrics management component 113 can use the following formula, expressed as formula 2, to determine the bin upper boundaries for a set of bins:

$$Bin Upper Boundary = {I}_{bin} * {C}_{1} - {offset}_{0} , {L}_{1} \leq {I}_{bin} \leq {L}_{2} \qquad ( 3 )$$

$${I}_{bin} * {C}_{2} - {offset}_{1} , {L}_{3} \leq {I}_{bin} \leq {L}_{4} ,$$

$${I}_{bin} * {C}_{3} - {offset}_{2} , {L}_{5} \leq {I}_{bin} \leq {L}_{6} ,$$

$${I}_{bin} * {C}_{4} - {offset}_{3} , {L}_{7} \leq {I}_{bin} \leq {L}_{8} ,$$

where: I_{bin} is a particular Bin index number (e.g., 1, 2, 3, . . . , M), L_{y} is a constraint value reflecting for which bins the corresponding equation is used, and C_{z} represents one or more value that can be used to modify the I_{bin} value.

An illustrative example of formula 3 can be seen below, expressed as formula 4, which can be used to determine the bin upper boundaries for bin 0-39.

$$Bin Upper Boundary = {I}_{bin} * 4 - {offset}_{0} , 0 \leq {I}_{bin} \leq 9 , {offset}_{0} = 0 \qquad ( 4 )$$

$${I}_{bin} * 8 - {offset}_{1} , 10 \leq {I}_{bin} \leq 19 , {offset}_{0} = 32$$

$${I}_{bin} * 16 - {offset}_{2} , 20 \leq {I}_{bin} \leq 29 , {offset}_{0} = 184$$

$${I}_{bin} * 32 - {offset}_{3} , 30 \leq {I}_{bin} \leq 39 , {offset}_{0} = 648$$

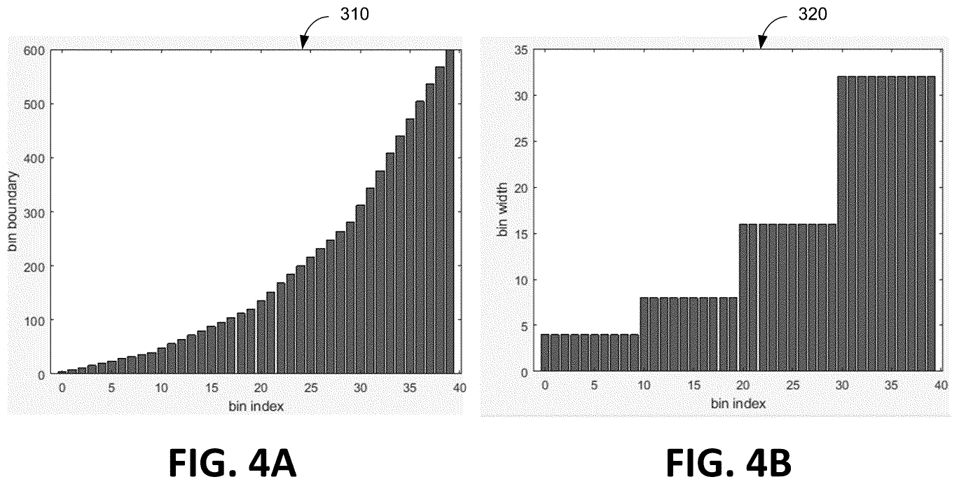

As shown in formula (4), for bins indexed as 0 through 9, to obtain the bin upper boundary, metrics management component 113 multiplies the respective bin number by a value of 4, then subtracts the value of offset₀ (e.g., 0) from the sum. To obtain the bin upper boundary for bins indexed as 10 through 19, metrics management component 113 multiplies the respective bin number by a value of 8, then subtracts the value of offset₁ (e.g., 32) from the sum. To obtain the bin upper boundary for bins indexed as 20 through 29, metrics management component 113 multiplies the respective bin number by a value of 16, then subtracts the value of offset₂ (e.g., 184) from the sum. To obtain the bin upper boundary for bins indexed as 30 through 39, metrics management component 113 multiplies the respective bin number by a value of 32, then subtracts the value of offset₃ (e.g., 648) from the sum. This allows different groups of bins to reflect different resolutions of BECs, as will be shown below with regards to FIG. 4B.

FIGS. 4A-4B are graphs that illustrate properties of bins that were generated using formula 4, in accordance with implementations of the present disclosure. In particular, graph 410 of FIG. 4A illustrates the bin boundaries for a set of bins while FIG. 4B illustrates the bin width for the set of bins. In graph 410, the y-axis is indicative of the bin upper boundary value and the x-axis is indicative of the bin index (e.g., bin identifier). In graph 420, the y-axis is indicative of the bin width and the x-axis is indicative of the bin index.

As shown in graph 410, the bin boundaries increase by a first linear factor for bins 0-9, by a second linear factor for bins 10-19, by a third linear factor for bins 20-29, and by a fourth linear factor for bins 30-39. As shown in graph 420, the resulting bin boundaries set bins 0-9 to a width of 4, bins 10-19 to a width of 8, bins 20-29 to a width of 16, and bins 30-39 to a width of 32.

In some implementations, the resolution of each bin (e.g., bin properties such as bin width, bin boundaries, etc.) or set of bins can be set automatically or using user input. For example, it may be desirable to have a higher bin resolution (e.g., shorter bin width) for certain BEC values to better anticipate end of life events (e.g., indicates that a memory device is no longer able to correct codewords due to a high BEC). As such, referring to formula 4, for bins 30-39, the expression can be modified to: I_{bin}*4−offset₃, 30≤I_{bin}≤39, offset₀=−164. Thus, for bins 30-39, the bin width is 4.

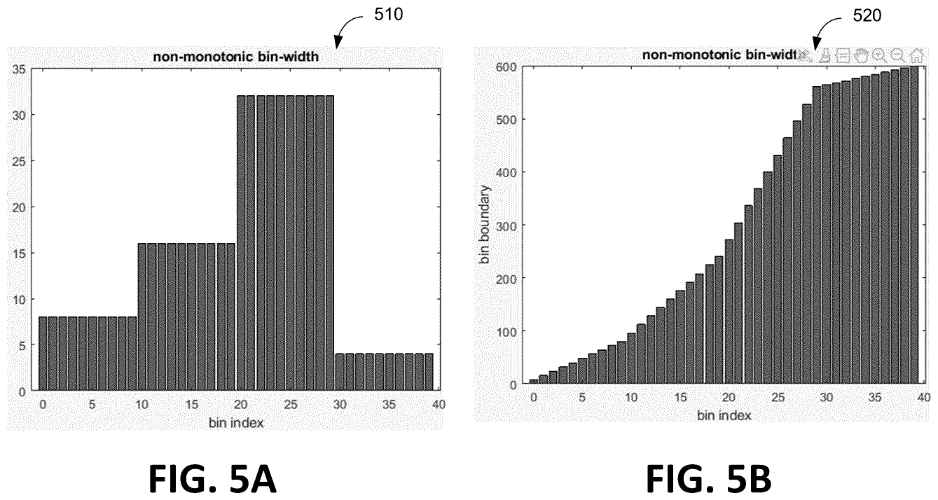

FIGS. 5A-5B are graphs that illustrate another set of bins generated using a piecewise linearization technique, in accordance with implementations of the present disclosure. In particular, graph 510 of FIG. 5A illustrates the bin boundaries for a set of bins while FIG. 5B illustrates the bin width for the set of bins. In graph 510, the y-axis is indicative of the bin upper boundary value and the x-axis is indicative of the bin index (e.g., bin identifier). In graph 520, the y-axis is indicative of the bin width and the x-axis is indicative of the bin index. As shown, the bin width for each bin of bins 0-9 is 8, the bin width for each bin of bins 10-19 is 16, the bin width for each bin of bins 20-29 is 32, and the bin width for each bin of bins 30-39 is 4.

In another example, the metrics management component 113 can analyze a metrics dataset (e.g., a set of BEC values) obtained from a media scan. The media scan can generate the dataset by performing a set of read and ECC operations that iteratively generate data state metrics (e.g., BEC values) for a set of codewords. The metrics management component 113 can then determine whether a number or a range of BEC values satisfies a threshold criterion (e.g., the number or range of BEC values is greater than or less than a threshold value). Responsive to the number or range of BEC values satisfying a threshold criterion, the metrics management component 113 can adjust a bin boundary formula to generate bins of a particular width for the BEC values. For example, responsive to determining that 90% of the BEC values obtained from the media scan correspond to between 100 and 150 bit errors per codeword, the metrics management component 113 can adjust a predetermined formula (e.g., obtained based on the exponential technique or piecewise linearization technique) increase the number of bins that store 100 to 150 bit errors per codeword, while increasing other bin widths outside the 100 to 150 bit errors per codeword range. This will increase the resolution of the dataset while minimizing memory dedicated to unused or sparsely used bins.

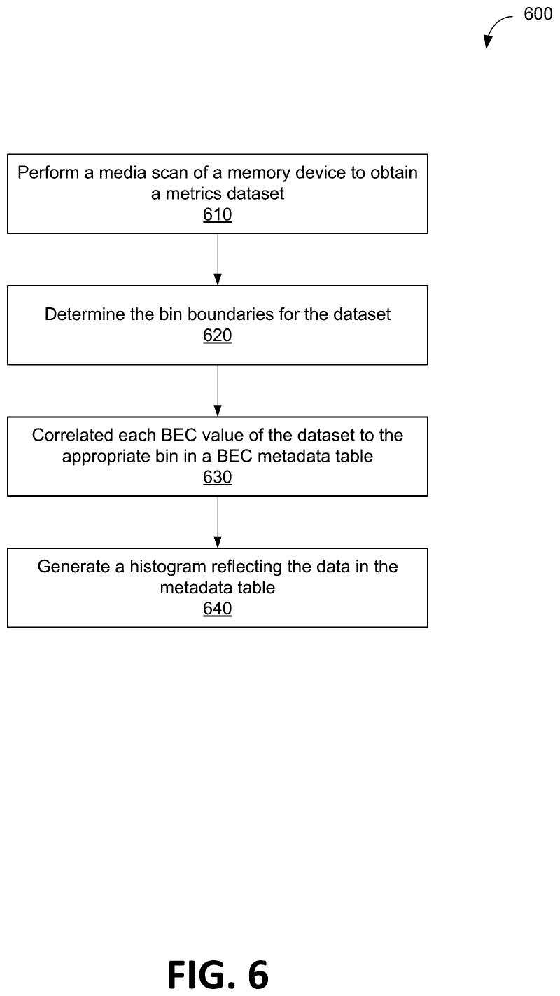

FIG. 6 is a flow diagram of an example method 600 for compressing a histogram reflecting the data stored in the metadata table, in accordance with some implementations of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, the method 600 is performed by the metrics management component 113 of FIG. 1. In other or similar implementations, one or more operations of method 600 is performed by another component of the memory sub-system controller 115, or by a component of local media controller 135. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 610, the processing logic performs a media scan of a memory device to obtain a metrics dataset. The media scan can be performed on one or more memory regions of the memory device. Each memory region can correspond to one or more logical units (LUNs), such as, for example, a die, a block, a page, a memory stripe, a management unit (MU) or any other measurable or manageable unit of the memory sub-system 110. In some implementations, the media scan can be performed as a set of background operations. The background operations can run in the background of the memory device during idle periods in which the memory device is not performing other operations in response to host-initiated commands. In some implementations, the media scan can be performed as foreground operations of the memory device in response to host-initiated commands (e.g., read commands), according to a predetermined schedule, or any combination thereof. In an illustrative example, the processing logic can iteratively read a number of pages in a particular LUN. For each codeword read from the pages, the processing logic can determine the codeword's bit error count (BEC).

At operation 620, the processing logic determines the bin boundaries for the dataset. In some implementations, the processing logic can apply a predetermined technique (e.g., an exponential technique or a piecewise linearization technique) to generate the bin boundaries. In some implementations, the processing logic can modify an existing formula(s) correlated to a predetermined technique. This modification can be performed by the processing logic determining that the values of the dataset satisfy a threshold criterion, based on user input, etc.

At operation 630, the processing logic correlates each BEC value of the dataset to the appropriate bin in a BEC metadata table. For example, the processing logic can increment a counter value of a bin for each corresponding BEC value. The BEC metadata table (e.g., table 200) can reflect the bin boundaries determined in operation 620.

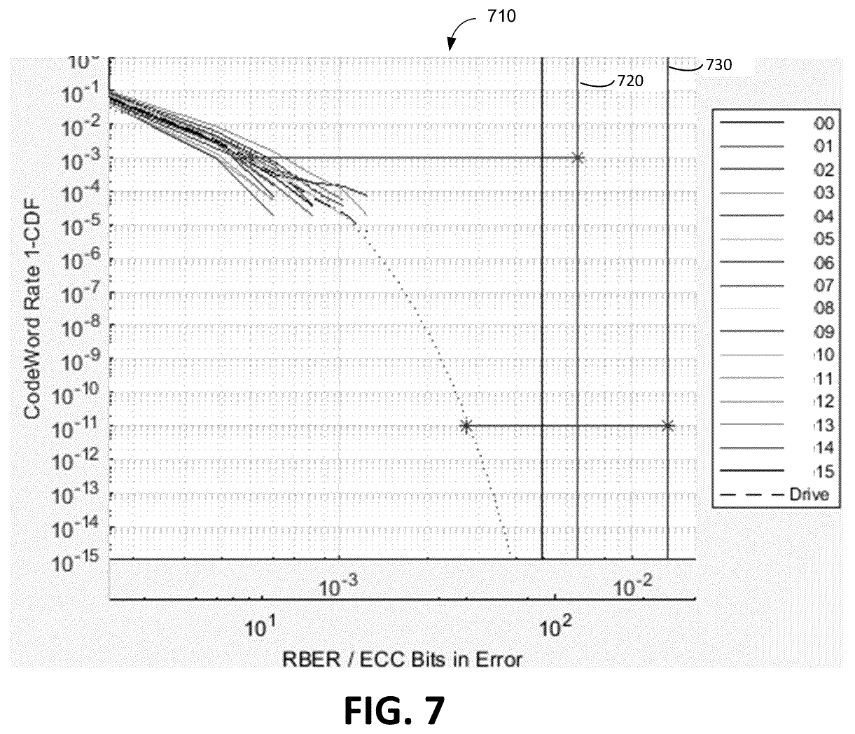

At operation 640, the processing logic generates a histogram reflecting the data in the metadata table. In some implementations, the histogram can be a graph indicative of the BEC of different LUNs of the memory device. FIG. 7 is an example histogram (plot) generated from a BEC metadata table, according to implementations of the present disclosure. In particular, the histogram shows the decadic values of each LUN versus the BEC values of each bin. Threshold 730 is a threshold limit indicative of a point to where data stored on a corresponding memory region is corrupted and/or is not recoverable while threshold 720 can be a soft threshold limit indicative of a warning that the memory region is approaching threshold 730.

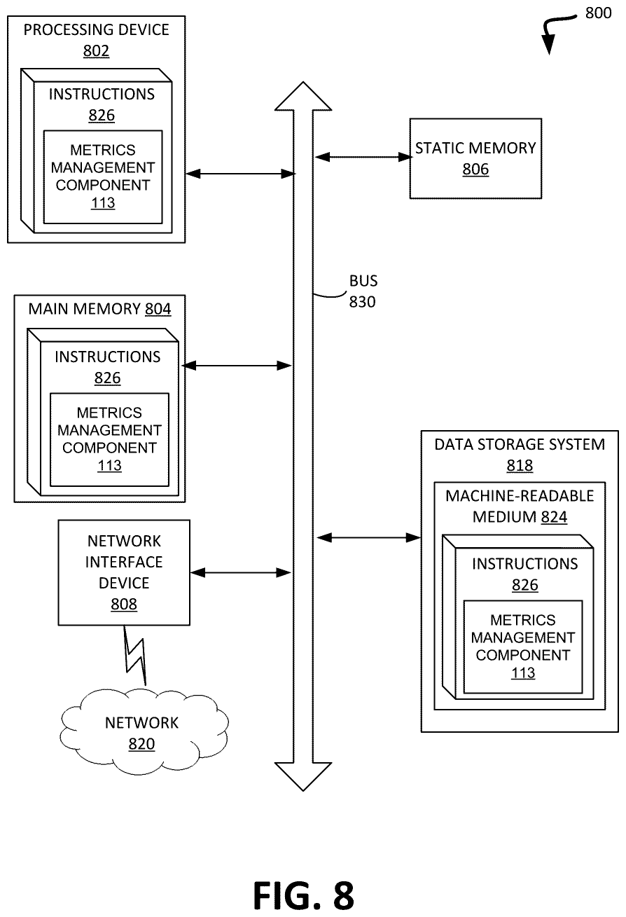

FIG. 8 illustrates an example machine of a computer system 800 within which a set of instructions, for causing the machine to perform any one or more of the methodologies discussed herein, can be executed. In some implementations, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media management component 113 of FIG. 1). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or RDRAM, etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 518 can include a machine-readable storage medium 824 (also known as a computer-readable medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. The machine-readable storage medium 824, data storage system 818, and/or main memory 804 can correspond to the memory sub-system 110 of FIG. 1.

In one implementation, the instructions 826 include instructions to implement functionality corresponding to a voltage bin boundary component (e.g., the media management component 113 of FIG. 1). While the machine-readable storage medium 824 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, to perform operations comprising;
performing a media scan on a portion of the memory device to obtain a metrics dataset comprising a plurality of data state metric values, wherein each data state metric value is associated with a respective codeword of a plurality of codewords stored on the portion of the memory device;
generating, for the metrics dataset, a plurality of data state metric bins comprising a first set of bins having a first bin width and a second set of bins having a second bin width;
associating a first data state metric value of the plurality of data state metric values with a first bin of first set of bins, and a second data state metric value of the plurality of data state metric values with a second bin of the second set of bins, wherein the first data state metric value exceeds the second data state metric value; and
generating a histogram reflecting the data associated with the plurality of data state metric bins.

2. The system of claim 1, wherein a bin boundary is determined based on a value obtained from a bin identifier used as an exponent value of a particular base value.

3. The system of claim 1, wherein a bin boundary is determined by multiplying a bin identifier by a first value and offsetting a resultant value by a second value, wherein the bin identifier is a sequential number of the respective bin.

4. The system of claim 1, wherein the operations further comprise:
generating a modified data state metric value by applying a logarithmic operation to a data state metric value of the plurality of data state metric values.

5. The system of claim 1, wherein the histogram is represented by a graph.

6. The system of claim 1, wherein the data state metric value reflects at least one of a bit error count (BEC) value or a raw bit error rate (RBER) value.

7. The system of claim 1, wherein the data state metric bins are each constrained by a pair of bin boundaries, wherein the bin boundaries set a first bin of the plurality of data state metric bins to a first bin width value and a second bin of the plurality of data state metric bins to a second bin width value.

8. A method comprising:
performing, by a processor, a media scan on a portion of the memory device to obtain a metrics dataset comprising a plurality of data state metric values, wherein each data state metric value is associated with a respective codeword of a plurality of codewords stored on the portion of the memory device;
generating, for the metrics dataset, a plurality of data state metric bins comprising a first set of bins having a first bin width and a second set of bins having a second bin width;
associating a first data state metric value of the plurality of data state metric values with a first bin of first set of bins, and a second data state metric value of the plurality of data state metric values with a second bin of the second set of bins, wherein the first data state metric value exceeds the second data state metric value; and
generating a histogram reflecting the data associated with the plurality of data state metric bins.

9. The method of claim 8, wherein a bin boundary is determined based on a value obtained from a bin identifier used as an exponent value of a particular base value.

10. The method of claim 8, wherein a bin boundary is determined by multiplying a bin identifier by a first value and offsetting a resultant value by a second value, wherein the bin identifier is a sequential number of the respective bin.

11. The method of claim 8, further comprising:
generating a modified data state metric value by applying a logarithmic operation to a data state metric value of the plurality of data state metric values.

12. The method of claim 8, wherein the histogram is represented by a graph.

13. The method of claim 8, wherein the data state metric value reflects at least one of a bit error count (BEC) value or a raw bit error rate (RBER) value.

14. The method of claim 8, wherein the data state metric bins are each constrained by a pair of bin boundaries, wherein the bin boundaries set a first bin of the plurality of data state metric bins to a first bin width value and a second bin of the plurality of data state metric bins to a second bin width value.

15. A non-transitory computer-readable storage medium comprising instructions that, when executed by a processing device, cause the processing device to perform operations comprising:
performing a media scan on a portion of the memory device to obtain a metrics dataset comprising a plurality of data state metric values, wherein each data state metric value is associated with a respective codeword of a plurality of codewords stored on the portion of the memory device;
generating, for the metrics dataset, a plurality of data state metric bins comprising a first set of bins having a first bin width and a second set of bins having a second bin width;
associating a first data state metric value of the plurality of data state metric values with a first bin of first set of bins, and a second data state metric value of the plurality of data state metric values with a second bin of the second set of bins, wherein the first data state metric value exceeds the second data state metric value; and
generating a histogram reflecting the data associated with the plurality of data state metric bins.

16. The non-transitory computer-readable storage medium of claim 15, wherein a bin boundary is determined based on a value obtained from a bin identifier used as an exponent value of a particular base value.

17. The non-transitory computer-readable storage medium of claim 15, wherein a bin boundary is determined by multiplying a bin identifier by a first value and offsetting a resultant value by a second value, wherein the bin identifier is a sequential number of the respective bin.

18. The non-transitory computer-readable storage medium of claim 15, wherein the operations further comprise:
generating a modified data state metric value by applying a logarithmic operation to a data state metric value of the plurality of data state metric values.

19. The non-transitory computer-readable storage medium of claim 15, wherein the data state metric value reflects at least one of a bit error count (BEC) value or a raw bit error rate (RBER) value.

20. The non-transitory computer-readable storage medium of claim 15, wherein the data state metric bins are each constrained by a pair of bin boundaries, wherein the bin boundaries set a first bin of the plurality of data state metric bins to a first bin width value and a second bin of the plurality of data state metric bins to a second bin width value.
